(19) United States
(12) Patent Application Publication
(10) Pub. No.: US 2011/0313800 A1
(43) Pub. Date: Dec. 22, 2011

(54) Systems and Methods for Impact Analysis in a Computer Network

(76) Inventors: Mitchell Cohen, Ann Arbor, MI (US); G. Russell Merz, Ypsilanti, MI (US); Jeffrey L. Smith, Ann Arbor, MI (US); Heungsun Hwang, Verdun (CA)

(21) Appl. No.: 12/820,650

(22) Filed: Jun. 22, 2010

(51) Int. Cl. G06F 17/30

(52) U.S. Cl. 705/7.11; 705/7.29

(57) ABSTRACT

In accordance with the teachings of the present invention, a computer-implemented apparatus and method is provided for determining the impact of certain actions on the performance of a pre-specified or modeled system is provided. A manifest variable database is utilized for storing manifest variable data relating to user interaction with a system of interest. An imputation module may be coupled to the manifest variable database for calculating any missing manifest variables. Embodiments of the invention may further include a statistical weights calculator for determining strength of correlation among manifest and latent variables, a latent score calculator, a fuzzy clustering module that derives clusters or segments that have their own impacts and scores for a fitted model and constraining impact calculator that determines the impact of certain operations on the fitted model.

### BACKGROUND OF THE INVENTION

The present invention relates generally to statistical analysis computer systems. More particularly, the present invention relates to statistical impact analysis computer systems.

The desire to improve product quality and the end-user experience is ubiquitous to nearly all manufacturing and service industries. As a result, there is great interest in improving the quality of products and services and their environments through systematic performance evaluation followed by the completion of the business process. Some (but admittedly few) industries are fortunate to have easily quantifiable metrics to measure the quality of their products and services. Using these metrics a continuous improvement process can be implemented, whereby (a) the product or service is produced using existing processes and assessed using quantifiable metrics, (b) the existing processes are then changed based on the results of the metrics, and (c) the efficacy of the change is tested by producing the product or service again using the changed process and assessing using the same metrics.

For most industries, however, finding a good, quantifiable metric has proven elusive. For most industries, business processes have become complex and difficult to describe in quantitative terms. Human intuition and judgment play an important role in production of goods and services; and ultimately human satisfaction plays the decisive role in determining which goods and services sell well and which do not. In addition, there is a growing body of evidence suggesting that employee on-the-job satisfaction also has an enormous impact upon a company's bottom line.

Human intuition and judgment, customer satisfaction, employee satisfaction. These are intangible variables that are not directly measurable and must therefore be inferred from data that are measurable. Therein lies the root of a major problem in applying continuous improvement techniques to achieve better quality. The data needed to improve quality are hidden, often deeply within reams of data the organization generates for other purposes. Even surveys expressly designed to uncover this hidden data can frequently fail to produce meaningful results unless the data are well understood and closely monitored.

Experts in statistical analysis know to represent such intangible variables as “latent variables” that are derived from measurable variables, known as “manifest variables.” However, even experts in statistical analysis cannot say that manifest variable A will always measure latent variable B. The relationship is rarely that direct. More frequently, the relationship between manifest variable A and latent variable B involves a hypothesis, which must be carefully tested through significant statistical analysis before being relied upon.

The current state of the art is to analyze these hypotheses on a piecemeal basis, using statistical analysis packages such as SPSS or SAS. However, these packages do not perform any statistical analysis based on a pre-defined model that approximates system structure or behavior. Furthermore, these packages lack a semi-automated process for examining the “manifest” variables (i.e., measured survey data) in many different cuts or segments using a model-based approach. Also, these packages have difficulty dealing with surveys where the data are incomplete or few responses have been gathered.

### SUMMARY OF THE INVENTION

The present invention is directed to overcoming these and other disadvantages of the prior art. In accordance with the teachings of the present invention, a computer-implemented apparatus and method is provided for determining the impact of certain actions on the performance of a pre-specified or modeled system is provided. A manifest variable database is utilized for storing manifest variable data relating to user interaction with a system of interest. An imputation module may be coupled to the manifest variable database for calculating any missing manifest variables.

Embodiments of the invention may further include a statistical weights calculator for determining strength of the causal relationship among manifest and latent variables, a latent score calculator, a fuzzy clustering module that derives clusters or segments that have their own impact and scores for a fitted model and constraining impact calculator that determines the impact of certain operations on the fitted model.

One aspect of the present invention includes a computer-implemented system for determining the impact of user actions on the performance of a pre-specified or modeled system, including a manifest variable database for storing manifest variable data indicative of user interactions; an imputation engine for estimating the value of any missing manifest data; a latent variable calculator for determining scores for latent variables based upon the stored manifest variables, the latent variables being indicative of customer characteristics; and an impact calculator for determining impact relationships among the latent variables based upon the stored latent variable scores.

Another aspect of the present invention is related to a computer implemented method, which may be embodied as computer code disposed on a computer readable medium, including storing manifest variable data indicative of user interactions, estimating the value of any missing manifest data; and determining scores for latent variables based upon the stored manifest variables, the latent variables being indicative of customer characteristics; and determining impact relationships among the latent variables based upon the stored latent variable scores.

For a more complete understanding of the invention, its objects and advantages, reference may be had to the following specification and to the accompanying drawings.

### BRIEF DESCRIPTION OF THE DRAWINGS

FIG. 1 is a software block diagram illustrating the top level software modules for a system constructed in accordance with the principles of the present invention;

FIG. 2 is a more detailed software block diagram further illustrating the system in FIG. 2; and

FIG. 3 is a diagram illustrating some of the calculated outputs of the systems shown in FIGS. 1 and 2.

FIG. 4 is a diagram illustrating some of the steps involved in the impact analysis of the present invention.

### DETAILED DESCRIPTION OF THE INVENTION

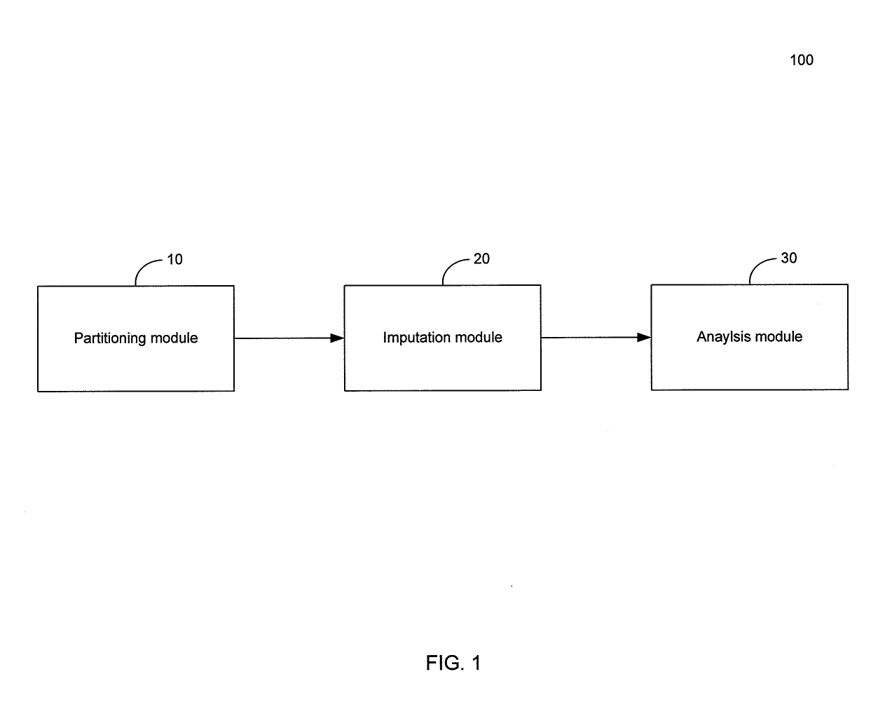

As shown in FIG. 1, the present invention may be generally arranged in three sections, partitioning module 10, imputation module 20 and analysis module 30. During operation, data, which may be in the form of survey responses, is processed by partitioning module 10 and grouped into subsets that facilitate the correlation of certain latent variables to certain manifest variables in the data. One way this may be accomplished is by separating surveys into smaller sections in order to reduce respondent fatigue. In some embodiments, these surveys may by stored in one or more pop-up servers and provided to respondents on rotating basis.

Next, imputation module 20 may estimate or otherwise determine the value of any data “missing” from that provided to partitioning module 10. In embodiments of the invention, it is contemplated that at least some data will be “missing” in an effort to decrease the length of the required survey questionnaire (e.g., purposefully omitted but derivable from acquired data (i.e., survey responses).

For example, this may include the calculation of certain latent variables that are determined to be of interest to the underlying system. Analysis module 30 processes this information to determine how manifest variables, latent variables and/or other information may reflect the behavior or other attribute of a survey respondent in interacting with a certain application or when performing a certain set of tasks. For example, analysis module 30 may determine the level of customer satisfaction based on a pre-defined model using manifest and calculated latent variables.

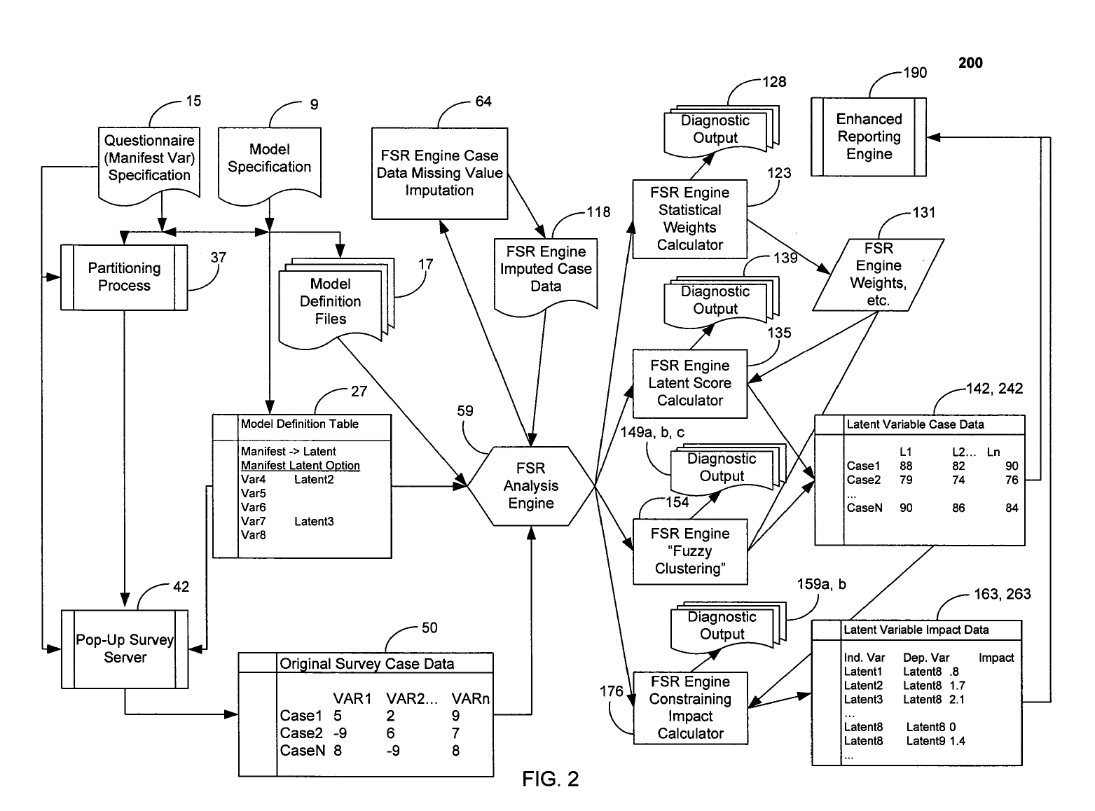

One embodiment of the present invention may be constructed as system 200, shown in FIG. 2. As shown, partitioning module 10 may include model specification module 9, survey questionnaire specification 15, model definition module 17, module definition table 27, partitioning process 37, and case level data table 50. However, it will be understood that other configurations of partitioning modules are also possible (i.e., to include additional or fewer resources, some modules may be combined, etc.).

In operation, survey questionnaire specification 15 may be used to create survey questions, the answers to which represent the data required to determine various attributes relating to a topic of interest that generally cannot be directly measured from the questions alone (e.g., customer satisfaction, application interaction, etc.). This may be done in order to create a framework or fitted model that is tailored to a specific area or topic of interest (e.g., customer satisfaction). Such information may vary depending on how the systems and methods described herein are applied.

Responses to these questions represent manifest data. For example, such questions may ask a customer to indicate on a scale from 1-10 their level of satisfaction relative to certain attributes associated with an online purchase. One such attribute might be whether an ordered product was delivered to the customer in a timely fashion.

In some embodiments of the invention, survey questions may be generated substantially automatically by specification module 15 after an end user inputs certain information relating to the topics of interest and the type of interaction data available (e.g., during an initialization process and through the use of a specialized customization tool or interface (not shown)). In other embodiments, such questions may be created by a system vendor based on information provided by an end user, or may be generated by the end user itself.

After the survey questions are complete, they may be stored in specification module 15 or in an optional survey server 42, which, in some embodiments, may be external to and separate from system 200. In operation, these questions are posed to customer or user in the form of a survey in order to collect responses (e.g., before or after an online purchase).

It will be understood from the foregoing that survey questions may be formulated in an iterative fashion, such that initially, survey results may be obtained and analyzed, with questions changed in order to obtain the desired (or necessary) data or to improve focus, resolution or efficiency. This also may be done substantially automatically by system 100 or with some direct end user participation.

Certain portions of the survey responses may be stored in the model definition database module 27 and/or in model definition module 17. Model specification 9 may use this information to relate certain manifest variables to latent variables, and may store those relationships (e.g., in the model definition database module 27).

Generally speaking, it is desirable for the survey questionnaires to be as brief as possible to minimize the burden on the respondent and thereby improve the likelihood of customer participation. On the other hand, having more manifest variables allows the collection of case data over a broader range of measuring points. By using partitioning process 37 and missing value imputation module 64, survey questions can be grouped together so that portions of these questions are consistently presented in the surveys in a way that produces shorter surveys that generate accurate, measurable data that otherwise would require more questions. For example, questions which relate to or depend from previous responses may be used, which may streamline or obviate the need for additional or more specific questions and improve data quality.

Partitioning process 37 may include certain code that divides the survey results into smaller, more discrete sections, that allows for the “backfilling” of any missing data through imputation (discussed in more detail below). In some embodiments, survey questions may be grouped and processed in accordance with some or all of the methods and processes described in U.S. Pat. No. 6,192,319, which is hereby incorporated by reference in its entirety.

Survey responses are recorded in case level database 50. This may include a relational database or matrix format in some embodiments. This manifest data may then be used as the basis from which latent variables are extracted and further processed in accordance with aspects of the present invention. For example, certain manifest variables may be needed in order to calculate latent variables related to parameters of interest. Some of those manifest variables may be missing from the survey results (either by design or lack of user response). In this case, such values may need to be determined in order to produce the analytical results discussed further herein.

As shown in FIG. 1, this may be accomplished by the use of imputation module 20, which may include missing value imputation module 64 (FIG. 2). Module 64 may access survey results in database 50 and combine that data with information from model definition module 27 to determine a value for any missing case level data. One way this may be accomplished is through the use of equation (1):

Φ=SS(SV−SWA)=SS(Ψ−ΓA) (1)

This Generalized Structured Component Analysis (GSCA) based formula may be used to estimate the value of any missing observation S. Generally speaking, equation (1) may be minimized to determine S using a model estimation approach and a data transformation approach whereby through certain assumptions, such as fixing model parameters S and A, equation (1) can be re-expressed as equation (2):

Φ=SS(SΣ) (2)

S may then be obtained by employing a least squares model prediction on equation (2). This approach allows the present invention to calculate the missing observation(s) and recover the initial data, which can be used in subsequent analysis stages.

For example, the results of this calculation may be used to populate imputed case database 118 with any data that may be missing from case level database 50 (i.e., the survey results). At this point, each case should have complete survey data which may be used in other analysis modules.

The information in imputed case database 118 may then be used by analysis module 30. As shown in FIG. 2, analysis module 30 may include analysis engine 59, statistical weights calculator 123, latent score calculator 135, fuzzy clustering module 154 and constraining impact calculator 176. In operation, analysis engine 59 may employ the other modules in analysis module 30 in order to generate certain results. However, it will be understood that other configurations of analysis module 30 are also possible (i.e., include additional or fewer resources, some modules may be combined, etc.).

For example, analysis engine 59 may employ statistical weights calculator 123 to determine how much each manifest variable contributes to one or more of the calculated latent variables. Based on information in the model definition files module 17, the model definition module 27 and the case level data (50 or 118), a GSCA-based algorithm using equations 1 and 2 computes the standardized and unstandardized loadings and weights for the manifest variables in the model (stored in database 131). The weights represent the relative contribution of each manifest variable to the latent variable score. The loadings show how strongly correlated each variable is with its underlying latent variable. The weights may be used for the calculation of the optimal case-level latent variable scores.

If desired, in some embodiments, a diagnostic output 128 may be generated that may be used to calculate standard errors and t-ratios of both standardized and unstandardized weights and loadings for assessing the usefulness and statistical strength of each manifest variable in the model.

As shown in FIG. 2, latent score calculator 135 may use the weighted correlations stored in database 131 with the raw or imputed case level data (in database 50 or 118) in the structure defined by the measurement model in model definition module 17 to produce a case-level latent score for each specified latent variable in the model. Diagnostic outputs 139 allow a user to determine the construct validity and discriminant validity of the specified measurement model structure. The scores produced by the latent score calculator 135 may be saved in an output file 142 for use in other modules of system 200.

Furthermore, analysis engine 59 may employ a fuzzy clustering analysis module that uses the weighted correlation information in database 131 together with raw or imputed case level data (50 or 118) along with information in the model definition module 17 to derive “clusters” or segments of case level data that possess relatively distinct characteristics in terms of a fitted model. This module provides the capability to identify different numbers of segments with their own impacts and scores (outputs 142 and 163) for the fitted model, and “fuzzy” or probabilistic segment membership for the cases. Users can specify the number of segments to be extracted from the data. This may illustrate how different that data in each cluster is compared to others clusters, which allows insight in changes and impacts that might not otherwise be visible. For example, this allows the decomposition of a large data set into smaller more homogeneous groups providing insight about scores and impacts that might not otherwise be visible. Each resulting segment model can be compared on the diagnostic outputs (149a, b and c) and the resulting saved segment level scores and impacts (242 and 263).

Furthermore, analysis engine 59 may employ a constraining Impact Calculator 176 that uses the latent variable scores 142 generated by the latent score calculator 135 with the structure defined by the measurement model in the model definition module 17 to produce the intercepts and impacts for the model to generate permissible solutions. For example, in some embodiments, it may allow a user to specify the permissible values that impacts can have in a path model. Thus if the underlying theory specifies that all predictors should have impacts of zero or greater, the constraining calculator will not allow negative impacts to be estimated. In some embodiments, this may constrain the impact values to be within certain pre-defined ranges that make sense within the model (e.g., must be greater than zero). The results may be saved in the latent variable impact data file 163.

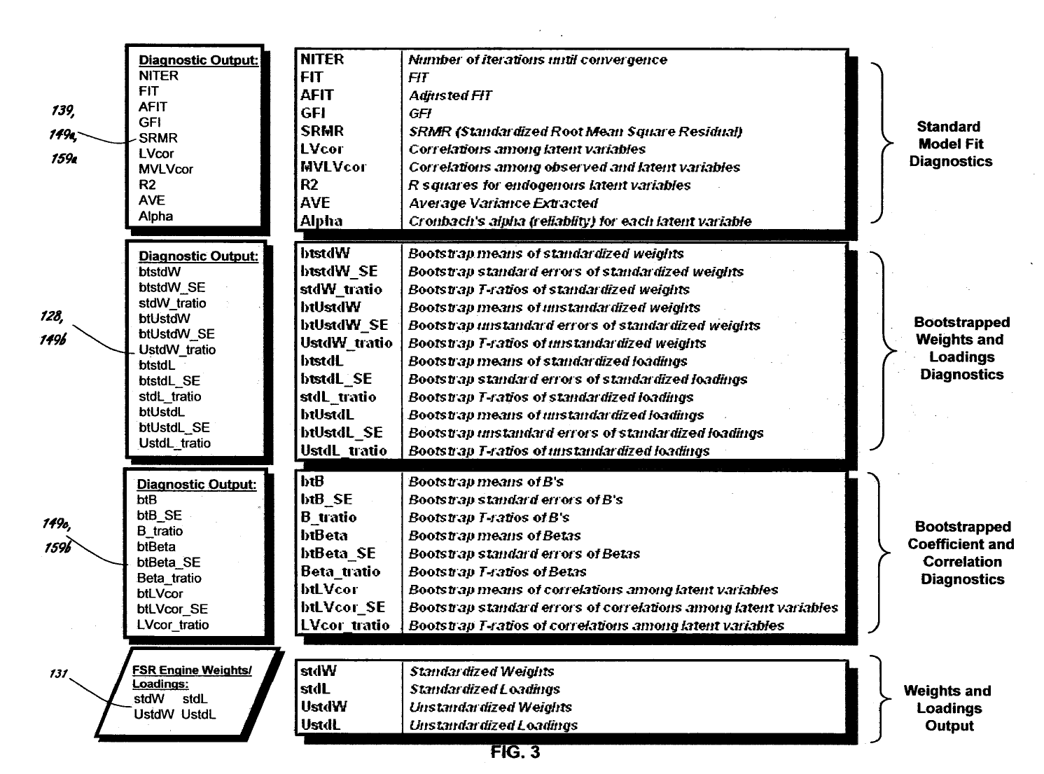

The diagnostic outputs described above may be provided in four categories of calculated outputs—Model Fit Diagnostics, Weights and Loadings Diagnostics, Coefficient and Correlation Diagnostics, and Weights and Loadings (shown in FIG. 3).

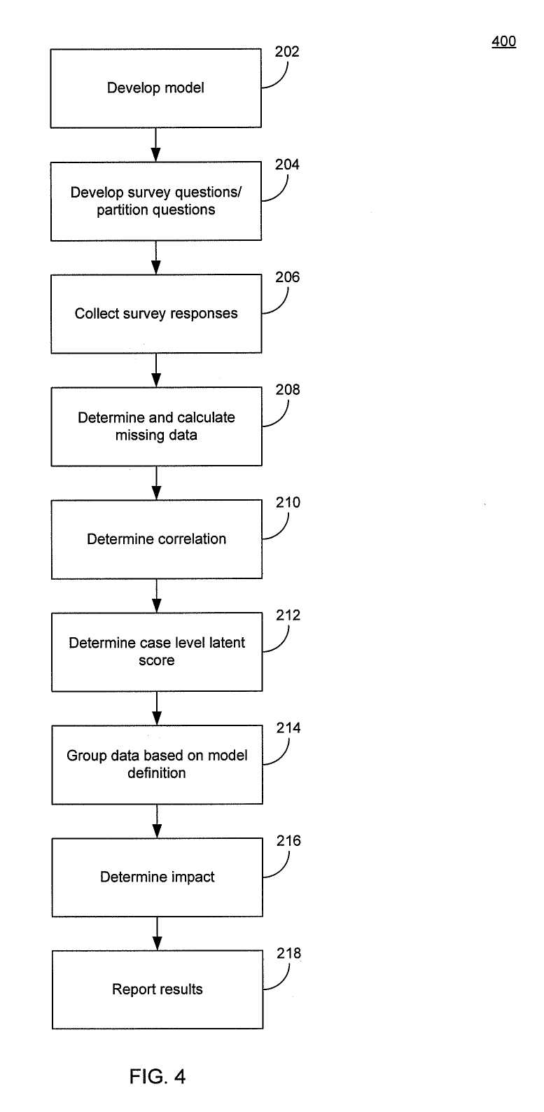

FIG. 4 illustrates a series of processing operations that may be implemented by the systems illustrated in FIGS. 1-2, according to an embodiment of the invention. In the first processing operation 202 of FIG. 4 a survey questionnaire specification may be used to create survey questions. This may be done in order to create a framework or fitted model that is tailored to a specific area or topic of interest (step 204). Such information may vary depending on how the systems and methods described herein are applied.

Next, at step 206, responses to the survey questions may be obtained which represent manifest data. In some embodiments of the invention, such questions may ask a customer to indicate on a numerical scale their level of satisfaction with respect to a certain product or service. Survey questions may be generated substantially automatically, by a system vendor based on information provided by an end user, or may be generated by the end user itself.

Certain portions of the survey responses may be stored in the model definition database module and/or in model definition module. The model specification may use this information to relate certain manifest variables to latent variables, and may store those relationships.

At step 206, survey questions may be grouped together so that portions of these questions are consistently presented in the surveys in a way that produces shorter surveys that generate accurate, measurable data that otherwise would require more questions. Moreover, such partitioning may divide the survey results into smaller, more discrete sections, that allows for the backfilling of any missing data through imputation.

Next, at step 208, any missing case data may be identified and calculated through imputation. One way this may be accomplished is through the use of the GSCA-based algorithm described above in conjunction with information from the fitted model. Once this process is complete, each case should have complete or substantially complete survey data which may be used in the steps further described below.

For example, such imputed case data may be used in additional analytical operations to determine the overall impact and influence on the object of interest. Some of these additional analytical operations may include one or more of the following: statistical weight calculations, latent score calculations, fuzzy clustering operations, constraining impact calculations, and analysis of the results of these operations.

For example, at step 210 statistical weight calculations may be performed on the imputed data set to determine how much each manifest variable contributes to one or more of the calculated latent variables. Based on information in the model definition files (17), the GSCA-based algorithm of equation 3 below may compute the standardized and unstandardized loadings and weights for the manifest variables in the model.

ø=SS(ZV−ZWA)=SS(Ψ−ΓA) (3)

This information may be used for the calculation of the optimal case-level latent variable scores.

At step 212 latent score calculations may be performed to produce a case-level latent score for each specified latent variable in the model. Certain diagnostic outputs may allow a user to determine the construct validity and discriminant validity of the specified measurement model structure.

At step 214, the process of the present invention may perform a fuzzy clustering analysis that uses the weighted correlation information described above together with raw or imputed case level data along with information in the fitted model definition to derive clusters of data that possess relatively distinct characteristics in terms of a fitted model. This provides the capability to identify different numbers of segments with their own impacts and scores for the fitted model, and “fuzzy” or probabilistic segment membership for the cases. Users can specify the number of segments to be extracted from the data.

At step 216, the process may perform a constraining impact calculation that uses the latent variable scores generated by the latent score calculation above with the structure defined by the model definition module to produce the intercepts and impacts for the model. In some embodiments, this may constrain the impact values to be within certain pre-defined ranges that make sense within the model (e.g., must be greater than zero). The results may be saved in the latent variable impact data file and provided to a reporting module that groups of formats the data for inspection by a user (step 218).

The systems, methods, apparatus and modules described herein may comprise software, firmware, hardware, or any combination(s) of software, firmware, or hardware suitable for the purposes described herein. The methods described herein may also be embodied in computer code disposed on a computer readable medium such as an optical or magnetic disk or in a semiconductor memory such as a thumb drive etc. Software and other modules may also reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. The data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information.

Moreover, it will be appreciated that the systems and methods provided herein are intended to exemplary and not limiting and that additional elements or steps may be added or performed in different order, if desired.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A computer-implemented system for determining the impact of user actions on the performance of a pre-specified or modeled system, comprising:
a manifest variable database for storing manifest variable data indicative of user interactions;
an imputation engine for estimating the value of any missing manifest data; and
a latent variable calculator for determining scores for latent variables based upon the stored manifest variables, the latent variables being indicative of customer characteristics; and
an impact calculator for determining impact relationships among the latent variables based upon the stored latent variable scores.

2. The computer-implemented system of claim 1 further comprising a statistical weights calculator to determine how much each manifest variable contributes to one or more of the calculated latent variable scores.

3. The computer-implemented system of claim 1 wherein the imputation engine employs a Generalized Structure Component Analysis (GSCA) algorithm.

4. The computer-implemented system of claim 2 wherein the imputation engine employs a Generalized Structure Component Analysis (GSCA) algorithm.

5. The computer-implemented system of claim 1 further comprising a clustering module that groups together data having similar characteristics.

6. The computer-implemented system of claim 5 the clustering module groups together data having similar characteristics in terms of a fitted model.

7. The computer-implemented system of claim 1 wherein the impact calculator further comprises a constraining module that generates impact results within a certain pre-defined range.

8. The computer-implemented system of claim 1 wherein the stored latent variables are indicative of a user attribute.

9. The computer-implemented system of claim 8 wherein the user attribute is consumer satisfaction.

10. A computer-implemented method for determining the impact of user actions on the performance of a pre-specified or modeled system, comprising:
storing manifest variable data indicative of user interactions;
estimating the value of any missing manifest data; and
determining scores for latent variables based upon the stored manifest variables, the latent variables being indicative of customer characteristics; and
determining impact relationships among the latent variables based upon the stored latent variable scores.

11. The computer-implemented method of claim 10 further comprising determining how much each manifest variable contributes to one or more of the calculated latent variable scores.

12. The computer-implemented method of claim 10 wherein the imputation engine employs a Generalized Structure Component Analysis (GSCA) algorithm.

13. The computer-implemented method of claim 12 wherein the imputation engine employs a Generalized Structure Component Analysis (GSCA) algorithm.

14. The computer-implemented method of claim 10 further comprising grouping data together having similar characteristics.

15. The computer-implemented method of claim 10 wherein the determining impact relationships further comprises generating impact results within a certain pre-defined range.

16. The computer-implemented method of claim 1 wherein the latent variables are indicative of a user attribute.

17. The computer-implemented method of claim 16 wherein the user attribute is consumer satisfaction.

18. A computer readable medium having stored thereon a plurality of sequences of instruction, which, when executed by one or more processors cause an electronic device to:
store manifest variable data indicative of user interactions;
estimate the value of any missing manifest data; and
determine scores for latent variables based upon the stored manifest variables, the latent variables being indicative of customer characteristics; and
determine impact relationships among the latent variables based upon the stored latent variable scores.

19. The computer-readable medium of claim 18 further including instructions which determine how much each manifest variable contributes to one or more of the calculated latent variable scores.

20. The computer-readable medium of claim 18 further including instructions which employ a Generalized Structure Component Analysis (GSCA) algorithm in estimating the value of any missing manifest data.

21. The computer-readable medium of claim 18 further including instructions which group data together having similar characteristics.
